(19) United States
(12) Patent Application Publication
(10) Pub. No.: US 2002/0170281 A1
(43) Pub. Date: Nov. 21, 2002

(54) Method and nozzle for cleaning undedrside of a rotary mower

(76) Inventor: Rev. Steven H. Brown, Port Angeles, WA (US)

Correspondence Address: Robert W. Jenny, Apt. 313, 319-101st SE, Bellevue, WA, 98004, US

(21) Appl. No.: 09/829,562

(22) Filed: Apr. 11, 2001

(51) Int. Cl. A01D 75/10

(52) U.S. Cl. 56/12.1

(57) ABSTRACT

The primary feature of the invention is a nozzle end which extends downward through a hole in the deck of a rotary mower and has a plurality of orifices, some of which are parallel to the deck and some are angled downward at an angle in a range of 1° to 45°. The orifices are radial from the axis of the nozzle end. The cleaning is done by supplying water to the orifices at household pressure while the mower is running at mowing speed. The nozzle having the nozzle end may be installed in the deck or manually held in place during use.

### BACKGROUND OF THE INVENTION

1. Field

The subject invention is in the field of equipment used to inject liquids onto surfaces and/or onto the interior surfaces of enclosed or partially enclosed spaces for the purposes of cleaning or coating the surfaces. Such equipment includes automatic dishwashers, painting apparatus and lubrication equipment. More particularly, it is in the field of equipment which sprays water onto the interior surfaces of a partially enclosed space to clean out the space and clean off the interior surfaces of the space. Specifically, it is in the field of water spraying equipment or apparatus used to remove cut grass and associated debris from the inner surfaces of the partially enclosed space in the shroud of a rotary mower. Such shrouds comprise a deck which is generally horizontal when in use and a skirt which extends downward from the perimeter of the deck.

2. Prior Art

The U.S. patents listed below are a sample of the prior art in the specific field of the subject invention:

| | |
|---|---|
| 3,856,028 | 5,651,242 |
| 5,042,242 | 5,673,856 |
| 5,499,492 | D350,357 |

The closest prior art to the subject invention is disclosed in U.S. Pat. Nos. 5,499,492 (Jameson). Disclosed in this patent is an attachment which clamps onto the skirt of a rotary mower and has a passageway for water supplied by a hose to the attachment. The water is ejected as a jet rather than a spray, from a nozzle of the attachment and directed (1) inwardly and upwardly against the lower surfaces of the mower blades as they pass the nozzle, and (2) against the inner side of the deck of the shroud of the mower. The attachment is held in place by a thumbscrew. The portion of the attachment enclosing the passageway passes under the lower edge of the skirt.

This attachment is considered to be more cumbersome, complicated and expensive than necessary. Also, the use of a jet rather than a spray, directed against the undersurfaces of the blades, is considered to degrade the efficiency of the cleaning, using more water and time for the purpose than necessary. Also, the projection of the attachment below the skirt of the mower is not desirable, particularly when mowing uneven lawns.

Accordingly, the primary objective of the subject invention is to provide a method and related equipment, for cleaning the undersides of rotary mowers, which are less expensive, less cumbersome and more efficient than prior art equipment used for the same purpose. Another objective is that the equipment not project laterally from or below the mower skirt.

### SUMMARY OF THE INVENTION

The subject invention is a method for cleaning the underside of a rotary mower and a nozzle which is fundamental to the method. The underside of the mower is the lower surface of the deck and the inner surface of the skirt of the shroud of the mower. The axis of the nozzle, when installed or inserted in the deck is vertical (i.e. normal to the deck). The nozzle has a plurality of exit orifices, some directed horizontally and some at a small angle downward, all being directed radially from the axis of the nozzle. The nozzle is adapted to be connected to the end of a hose, preferably in combination with a valve. In use, with the mower running at operation speed, the water from the nozzle jets impinges on the inner surface of the skirt and the tops of the blades. Water impinging on the blades is accelerated forcibly by the blades against the inner surface of the skirt and the underside of the deck. In the embodiment of the invention in which the nozzle is inserted through the mower deck rather than installed in the deck, the nozzle may be attached to a wand which is attached to a hose which delivers water to the nozzle. In use the nozzle is inserted through a hole in the deck. Several holes may be provided. The nozzle has a shoulder which sets the depth of installation and/or insertion of the nozzle.

The invention is described in more detail below with reference to the attached drawings.

### BRIEF DESCRIPTION OF THE DRAWINGS

FIG. 1 illustrates a typical rotary mower with a preferred embodiment of the subject invention installed on the mower.

FIG. 2 is a partially sectioned view of a preferred embodiment of a nozzle assembly installed in the deck of a mower.

FIG. 3 is a sectional view taken at 3-3 in FIG. 2, showing a preferred arrangement of orifices in the end of the nozzle assembly.

FIG. 4 is a partially sectioned view of a nozzle which is inserted in the deck of a mower, rather than installed in the deck, for use in the subject invention.

FIG. 5 is a partially sectioned view of a nozzle assembly for use in the subject invention in the same way as the nozzle of FIG. 4 and incorporating a spring-loaded valve.

FIG. 6 illustrates an embodiment of the subject invention in which the valve of FIG. 4 or FIG. 5 is attached to a wand.

### DETAILED DESCRIPTION OF THE INVENTION

The subject invention is a method and nozzle for cleaning the underside of a rotary mower, specifically the inner surfaces of the deck and skirt of the shroud of the mower.

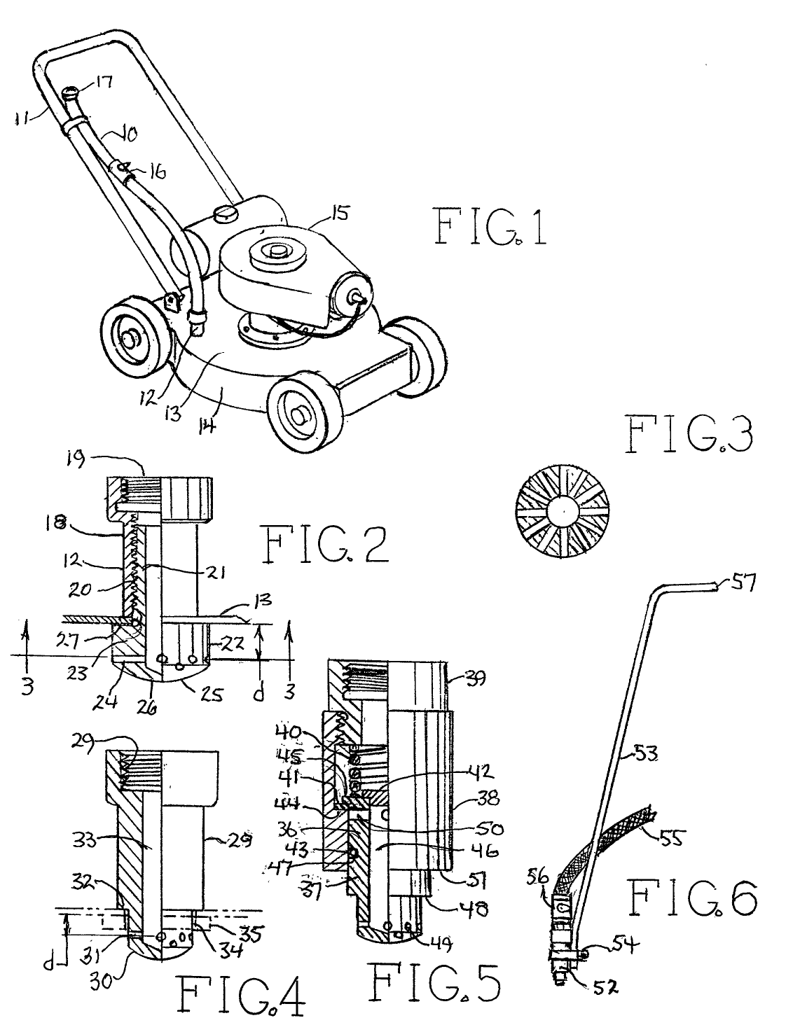

FIG. 1 illustrates a preferred embodiment of the subject invention. Hose assembly 10 is attached to handle 11 and nozzle 12 which is installed in deck 13 of shroud 14 of mower 15 The hose assembly comprises a valve 16. In use, end 17 of the hose assembly is attached to a water hose. To clean the underside of the mower, the mower is run at operational speed and valve 16 is opened so that water is sprayed from the nozzle as described in more detail below.

FIG. 2 is a partially sectioned view of nozzle assembly 12 according to the subject invention installed in the deck of a mower. Fitting 18 is threaded in portion 19 to accept the end fitting of a standard garden hose. Portion 20 is threaded to accept threaded portion 21 of fitting 22. Portion 22 is inserted through hole 23 in deck 13 and fitting 18 is threaded onto portion 21 to hold both fittings in place. There is a plurality of orifices, orifice 24 being typical, in end 25 of fitting 22. Typical orifice diameter is in a range of 1/32″ to ⅛″ with 5/64 preferred. The orifices extend radially from the axis of fitting 22 as shown in FIG. 3. Some are normal to the axis, such as orifice 24 and some are angled toward the end surface 26 of fitting 22 (i.e. downward when the fitting is installed), the angle being in a range of 45° to 90° to the axis with 70° preferred. Shoulder 27 on fitting 22 sets the distance d of the orifices below the deck. Distance d is in a range of ⅛″ to 1.0″ with ⅜″ preferred.

FIG. 4 is a partially sectioned view of a nozzle for use in a fundamental embodiment of the subject invention in which the nozzle is inserted into a hole in the deck of a mower for use, rather than being installed in the deck. Nozzle 28 is one piece, threaded in portion 29 to accept the end fitting of a standard garden hose, having orifices as described above near end 30, orifice 31 being typical, and having shoulder 32 to set the distance d of the orifices below the inner surface of the deck of a mower (shown in phantom lines). Hole 33 passes water from the hose (not shown) to the orifices. As shown, this nozzle is held in place while cleaning. It can be installed in deck 13 by threading portion 34 and using nut 35, shown in phantom lines. Portion 29 can be adapted to be attached to the end of a hose by being in the shape of a tube which fits closely inside of the hose and the connection is sealed by clamping the hose onto the tube shape.

FIG. 5 is a partially sectioned view of a nozzle assembly used in the subject invention in the same way as the nozzle of FIG. 4 but incorporating a spring loaded valve. Valve 36 comprises nozzle portion 37, housing 38, fitting 39, spring 40, valve seat 41, cap 42 and O ring 43. Fitting 39 enables attachment of a standard outlet fitting of a garden hose to the housing. Valve seat 41 is installed on shoulder 44 in the housing. Flange 45 on portion 37 contacts the valve seat. The spring presses flange 45 against the seat. Cap 42 prevents water from entering directly into hole 46 in portion 35. The O ring is installed in groove 47 to prevent leakage between the body and the nozzle portion. Shoulder 48 sets the distance the orifices, orifice 49 being typical, are below the inner surface of a deck when the nozzle assembly is in use. In use, pressing the body of the assembly against shoulder 48 moves the nozzle portion against spring force, and lifts flange 45 off the valve seat, allowing water to flow through hole(s) 50 into hole 46 and out of the orifices. End 51 of the housing limits the distance the nozzle portion can be moved into the housing. When the assembly is lifted off shoulder 48, flange 45 reseats and shuts off the flow of water.

FIG. 6 illustrates a nozzle or nozzle assembly 52 of the type shown in FIG. 4 or FIG. 5 attached to a handle or wand 53 by clamp 54. As shown, hose 55 is attached directly to the nozzle assembly or valve 56 if such a valve is installed between the nozzle assembly and the hose. However, the wand 53 may be a pipe or tube which conducts water to a nozzle assembly from a hose attached to the upper end 51 of the wand.

The diameter of the hole in the mower deck is larger than the diameter of the end of a nozzle or nozzle assembly and smaller than the diameter of the shoulder which sets the distance of the nozzle orifices away from (below) the inner surface of the mower deck.

The basic method of the subject invention comprises the steps of:

1) providing a nozzle adapted to be connected to a water supply, having an axis, having a nozzle end, having a first diameter and at least one orifice the nozzle end, the orifice being oriented radially from the axis and at an angle to the axis in a range of 90°-45°, the nozzle further comprising a shoulder having a second diameter and being perpendicular to the axis and a distance from the orifices in a range of ⅛ inch to 1.0 inches,

2) providing a hole in the deck of a rotary mower, the hole having a third diameter which is larger than the first diameter and smaller than the second, the hole being at a radius from the axis of the mower in a range of 0.5 to 0.95 of the radius of the shroud of the mower,

3) inserting the nozzle end in the hole with the shoulder contacting the deck,

4) running the mower at mowing speed,

5) causing water to flow through the nozzle end and out of the at least one orifice for sufficient time to clean the underside of the mower,

6) shutting off the water flow,

7) removing the water supply and, in some cases,

8) removing the nozzle end from the hole.

It is considered to be understandable from this description that the subject invention meets its objectives. It provides a method and related equipment for cleaning the undersides of rotary mowers. The cleaning is done more efficiently and less expensively than is possible with prior art methods and equipment used for the same purpose. It is less expensive in terms of equipment cost and time and water used. Also the equipment does not extend laterally from or below the skirt of the mower.

It is also considered to be understood that while certain embodiments of the invention are described herein, other embodiments and modifications of those described are possible within the scope of the invention which is limited only by the attached claims

I claim:

1. A method for cleaning the underside of a rotary mower, said mower having a first axis, a mowing speed and a shroud comprising a deck, a skirt and a first radius, said method comprising the steps of:
1. providing a nozzle adapted to be connected to a water supply, connecting said nozzle to said water supply, said nozzle having a second axis, a nozzle and having a first diameter and at least one orifice in said nozzle and said at least one orifice being oriented radially from said second axis and at an angle to said second axis in a range of 90° to 45°, said nozzle further comprising a shoulder having a second diameter and being perpendicular to said second axis and a distance from said at least one orifice in a range of ⅛″ to 1.0″,
2. providing a hole in said deck, said hole having a third diameter which is larger than said first diameter and smaller than said second diameter, said hole being located at a second radius from said first axis in a range of 0.5 to 0.95 of said first radius,
3) inserting said nozzle end into said hole with said shoulder contacting said deck,
4) running said mower at said mowing speed,
5) causing water from said water supply to flow through said nozzle and out of said at least one orifice for sufficient time to clean said underside,
6) closing off the flow of water from said water supply, and
7) removing said water supply.

2. The method of claim 1, further comprising the steps of removing said nozzle end from said hole.

3. In combination, a nozzle and a rotary mower, said mower having a shroud comprising a deck and a skirt, a first radius of said shroud and a hole in said deck, said hole having a first diameter and being at a second radius from said axis, said second radius being in a range of 0.5 to 0.95 of said first radius,
said nozzle having an axis and a first end adapted to be connected to a water supply and a nozzle end, said nozzle end having a shoulder and at least one orifice oriented radially from said axis and at an angle to said axis in a range of 45° to 90°, said shoulder being perpendicular to said axis and a distance from said at least one orifice in a range of ⅛″ to 1″, said nozzle having a passage for water from said first end to said at least one orifice.

4. In combination, a nozzle assembly and a rotary mower, said mower having a shroud comprising a deck and a skirt, a first radius of said shroud and a hole in said deck, said hole having a first diameter and being at a second radius from said axis, said second radius being in a range of 0.5 to 0.95 of said first radius,
said nozzle assembly having an axis and a first end adapted to be connected to a water supply and a nozzle end, said nozzle end having a shoulder and at least one orifice oriented radially from said axis and at an angle to said axis in a range of 45° to 90°,
said shoulder being perpendicular to said axis and a distance from said at least one orifice in a range of ⅛″ to 1″, said nozzle having a passage for water from said first end to said at least one orifice.

5. The nozzle assembly of claim 4 further comprising a valve in said passage for water.

6. The nozzle assembly of claim 4 comprising a first part and a second part, said deck having an outer surface and an inner surface, said first and second parts being threaded to enable threaded assembly of said first and second parts with said first part contacting said outer surface and said second part contacting said inner surface, whereby said nozzle assembly is installed in said hole in said deck.
